(19) United States
(12) Patent Application Publication
(10) Pub. No.: US 2026/0080442 A1
(43) Pub. Date: Mar. 19, 2026

(54) CONTEXTUAL RATING SYSTEM WITH STATISTICAL RELIABILITY CONFIDENCE METRIC

(71) Applicant: Vikram Joshi, New York, NY (US)

(72) Inventor: Vikram Joshi, New York, NY (US)

(73) Assignee: Vikram Joshi, New York, NY (US)

(21) Appl. No.: 19/396,223

(22) Filed: Nov. 20, 2025

Related U.S. Application Data
(60) Provisional application No. 63/792,236, filed on Apr. 21, 2025.

(51) Int. Cl. G06Q 30/0282; G06F 40/30

(52) U.S. Cl. CPC G06Q 30/0282; G06F 40/30

(57) ABSTRACT

A system and method for dynamic context-specific rating calculation is disclosed. The system receives a corpus of user reviews and a user-specified context indicator. A filtering module (110) identifies a subset of reviews whose text contains or is semantically relevant to the context indicator, optionally utilizing a Natural Language Processing (NLP) model. Ratings from the filtered subset are extracted and aggregated by a recalculation processor (120), which applies dynamic weighting factors and computes a statistical confidence metric based on the filtered subset's size or variance. The resulting context-specific rating and corresponding confidence metric (130) are displayed to the user, providing a performance metric relevant to a user-defined scenario (e.g., filtering a rating to a “Dinner” or “Service” score).

### CROSS-REFERENCE TO RELATED APPLICATIONS

This application claims the benefit of U.S. Provisional Patent Application No. 63/792,236, filed Apr. 21, 2025, titled “Context-Specific Dynamic Rating Algorithm Based on Filtered Review Subsets,” which is hereby incorporated by reference in its entirety.

### FIELD OF THE INVENTION

The present invention relates to systems and methods for processing and evaluating user-generated reviews, and more particularly to a context-specific dynamic rating algorithm that recalculates review scores based on filtered subsets of reviews, and further to generating a confidence metric reflecting the statistical reliability of the recalculated score.

### BACKGROUND OF THE INVENTION

Existing review platforms commonly aggregate all user ratings into a single average score. While this provides a high-level overview, it obscures meaningful variations. For example, a restaurant may achieve a high overall score while performing unevenly across different service categories.

Some systems in the art attempt to address this by performing sentiment analysis or mining specific “product features” to categorize comments (e.g., identifying positive or negative sentiments associated with specific keywords like “dinner” or “service”). While these systems can display a filtered rating or a count of positive/negative opinions for a specific context, they create a new, unrecognized technical problem: statistical unreliability.

When a system dynamically filters a large dataset (e.g., 1,000 reviews) down to a specific context (e.g., 10 reviews), the resulting average rating becomes numerically unstable. However, current state-of-the-art systems present this filtered rating with the same visual authority as the overall rating. They fail to distinguish between a rating derived from statistically significant data and one derived from sparse data. Furthermore, existing systems that utilize “confidence” or “weights” typically rely on extrinsic factors, such as user click-through rates or psychological biometric data, rather than the intrinsic statistical variance of the text data itself. Accordingly, there is a need for a system that calculates a statistical confidence metric to quantify the reliability of context-filtered ratings.

### BRIEF SUMMARY OF THE INVENTION

The present invention provides a computer-implemented method, system, and computer-readable medium for dynamically recalculating user-generated review ratings based on context-specific filters. When a user supplies a keyword or phrase, the system identifies reviews whose text is relevant to that context, extracts their associated ratings, and computes a new, context-specific average. The resulting value provides a more accurate and personalized measure of quality within the selected condition, rather than a generalized overall score.

Unlike conventional electronic review systems that merely display a statistically static average, the present invention introduces a processor-implemented algorithm designed to solve the technical problem of numerically unreliable rating data generated by small subsets. This system calculates context-specific ratings and dynamically generates a statistical confidence metric (such as a Standard Error of the Mean or Confidence Interval) reflecting the statistical reliability of the underlying review subset. This is distinct from “confidence” measures related to user psychology or physiological states. The invention provides a non-conventional, integrated output that allows the user interface to dynamically adapt—for example, by suppressing unreliable ratings—thereby improving the accuracy and trustworthiness of the computer-generated data.

In one embodiment, the system includes a user interface through which a context indicator is received, a filtering engine that parses stored reviews to identify those matching the context, and a rating processor that aggregates and recalculates the ratings of the filtered subset. Optional weighting factors may be applied to account for review recency, reviewer credibility, or textual length. The recalculated context-specific rating, along with supporting metrics such as confidence levels and subset size, is then presented to the user.

In other embodiments, the system may incorporate artificial-intelligence or machine-learning components that enhance the identification and interpretation of relevant reviews. For instance, natural-language processing (NLP) models may detect contextually related feedback even where explicit keywords are absent, and sentiment-analysis algorithms may infer approximate ratings for reviews lacking numerical scores. These AI-based enhancements improve precision and scalability while preserving full operability in non-AI configurations.

The invention thus enables a flexible and extensible framework for delivering more transparent, context-aware evaluations. Users can refine ratings for specific situations—such as “dinner,” “delivery,” or “customer service”—and instantly view recalculated results that reflect those experiences. The system can be implemented across a range of domains, including hospitality, e-commerce, entertainment, and digital service platforms, thereby improving the accuracy, interpretability, and usefulness of crowd-sourced review data.

### BRIEF DESCRIPTION OF THE DRAWINGS

FIG. 1 illustrates a system-level architecture of the context-specific dynamic rating algorithm. The system includes a User Interface (100) that receives a Keyword Input (101) from a user and communicates with a Review Filter and Keyword Matcher (110). The filter component accesses a Synonym Dictionary (111) and may optionally employ an NLP Context Classifier (112) for semantic detection of relevant terms. The filtered results are processed by a Rating Recalculation and Statistical Processor (120), which contains a Rating Extractor (121), Sentiment Analyzer (122), Weighting Module (123), and Average and Confidence Calculator (124). In certain embodiments, a Machine-Learning Model (125) augments these calculations by refining weighting and sentiment inference. The resulting values are displayed to the user through the Contextual Rating Display (130), providing real-time context-specific feedback.

FIG. 2 is a flowchart illustrating the procedural steps of the dynamic, context-specific rating recalculation process. The operation begins at Start (200) and proceeds to Receive Keyword or Context Indicator (210), where a user provides a search term or phrase. The system then Parses and Filters Reviews (220) through both Keyword Match (221) and Synonym or AI Context Match (222) routines to identify reviews relevant to the specified context. The filtered subset is sent to Extract Ratings from Filtered Subset (230), which may also generate Sentiment-Derived Ratings (231) for text without explicit numerical scores. The next stage, Compute Context-Specific Rating (240), includes Apply Weighting Factors (241) and Compute Average and Confidence (242) operations. The results are then Displayed to the User Interface (250) before the process concludes at End (260).

FIG. 3 illustrates an exemplary user-interface embodiment configured to display both overall and context-specific ratings for comparison. The interface includes an Overall Rating Panel (300) presenting the aggregate score (for example, “Overall Rating: 4.6 (1000 reviews)”) and a Contextual Rating Panel (310) displaying results filtered by a user-specified keyword such as “Dinner,” together with the recalculated score (for example, “Filtered Rating: 3.7 (50 reviews)”) and an associated Confidence Value (0.84). A Display Logic Module (320) controls presentation behavior and incorporates a Toggle Control (321) for switching between views, a Graphical Indicator (322) such as stars, a bar, or a gauge to visualize rating magnitude, and an Optional AI-Enhanced Sentiment Summary (323) that provides qualitative insight derived from unscored text.

FIG. 4 illustrates an optional artificial-intelligence and machine-learning enhanced embodiment of the invention. The figure shows a Review Dataset Repository (400) receiving Raw Review Text (401) and User Metadata & Historical Ratings (402). These inputs are processed through an AI/ML Processing Layer (410) containing an NLP Context Detection Model (411), Sentiment Analysis Model (412), Weight Optimization Model (413), and a Model Training & Feedback Module (414). The resulting data are passed to a Rating Engine (420) that includes Aggregation Logic (421) and a Confidence Calculator (422). The computed Context-Specific Rating Output (430) is displayed through a User Interface Display (431) and may also be exported via Report Generation/API Output (432).

### DETAILED DESCRIPTION OF THE INVENTION

### A. Inputs and Data Structures

The system receives as input a dataset of user reviews, each review comprising:
i. Review text
ii. Numeric rating (if available)
iii. Metadata such as timestamp, user ID, and tags

The system also receives a user-specified context indicator, such as a keyword or phrase. Optional parameters may include weighting factors, sentiment-analysis models, and synonym lists.

### B. Contextual Filtering and Matching

The system parses all reviews to identify a subset whose text contains the user-specified keyword or its synonyms. The keyword may be matched using direct string matching or via a dictionary of synonyms.

In some embodiments, a trained natural language processing (NLP) model may be used to identify reviews contextually related to the keyword even when the term is not explicitly present. Such AI/ML enhancements are optional and serve to improve accuracy but are not required for the invention to function.

### C. Subset Extraction and Rating Inference

Reviews identified as contextually relevant form a filtered subset. Numeric ratings from these reviews are extracted. For reviews lacking explicit ratings, optional sentiment analysis or ML prediction may be applied to infer proxy ratings.

### D. Dynamic Rating Recalculation

The filtered ratings are aggregated to compute a context-specific rating. The aggregation may optionally apply weighting factors to individual reviews based on intrinsic properties of the review data. Unlike ranking weights derived from extrinsic user behavior (e.g., click-through rates or dwell time), the present invention applies weights based on: i. Review recency (time-decay weighting) ii. Reviewer credibility or verification status iii. Review length, helpfulness votes, or inferred linguistic certainty.

The system outputs the context-specific rating along with supporting statistics, including the number of reviews in the subset, the standard deviation, and the confidence metric C reflecting statistical reliability as detailed in section E.

### E. Computation of Statistical Reliability and Confidence Metric

The system dynamically generates a confidence metric C to quantify the statistical reliability of the context-specific rating R̅_{context}. This metric becomes particularly important when the filtered subset size n is small. By calculating C based on the variance (σ) and sample size (n) of the filtered subset, the system provides an objective measure of data quality that is independent of the sentiment analysis algorithm itself. This differs from “confidence scores” used in machine learning classifiers, which typically measure the probability that a classification label is correct (e.g., “80% sure this is a positive review”). The present invention's metric measures the reliability of the aggregate rating, not the classification accuracy of a single review.

In one embodiment, the confidence metric C is derived from the standard error of the mean (SEM) of the filtered subset's ratings, computed as:

$$S E M = \frac{σ}{\sqrt{n}} \qquad ( Equation 1 )$$

where σ represents the standard deviation of the ratings in the filtered subset and n denotes the number of reviews in that subset. A smaller SEM corresponds to higher statistical confidence.

In alternative or complementary embodiments, the confidence metric C may be expressed as a confidence interval (CI) surrounding the calculated R̅_{context}, such as a 95% interval. The system may display C as the width of this interval, such as R̅_{context}±CI_{width}, or normalize it into a percentage confidence score, such as C=1−(SEM/Range), for intuitive display through the User Interface.

The Display Logic Module (320) may use this metric to visually adjust or suppress presentation of context-specific ratings derived from statistically insufficient subsets, such as where n<30, thereby ensuring that the user interface reflects both rating magnitude and statistical reliability.

### F. Detailed Description of Figures

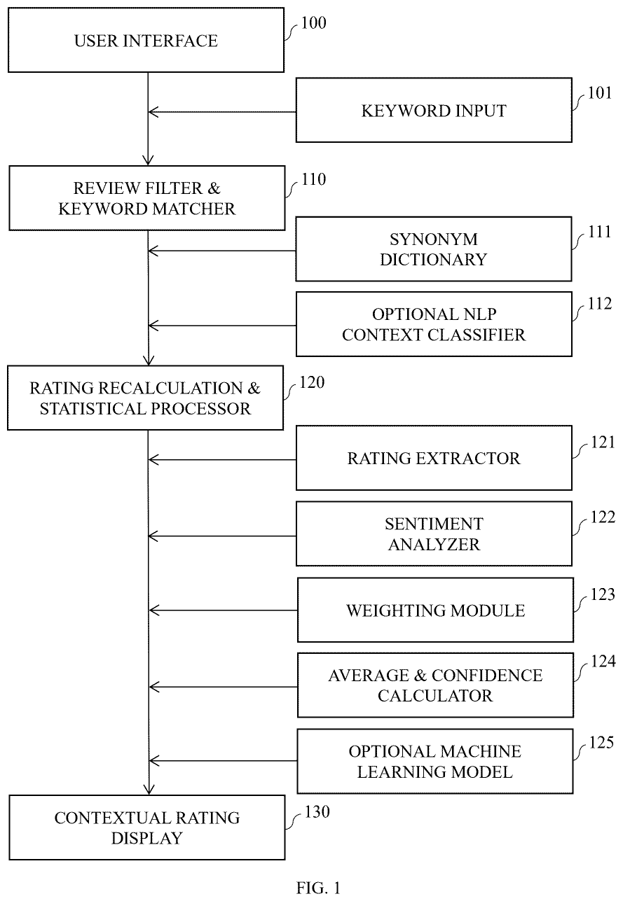

Referring now to FIG. 1, a block diagram of the principal system components implementing the context-specific dynamic rating algorithm is illustrated. The process begins with the User Interface (100), which presents a data-entry field or selection control serving as the Keyword Input (101). Users may specify a context indicator such as “Dinner,” “Breakfast,” or “Delivery.” The interface forwards the entered context to the Review Filter and Keyword Matcher (110), which retrieves stored reviews and identifies those containing the specified keyword. The matcher consults a Synonym Dictionary (111) to include equivalent or related terms and, in enhanced embodiments, utilizes an NLP Context Classifier (112) employing artificial-intelligence or machine-learning techniques to recognize semantically related content even when the keyword is not explicitly present.

Filtered reviews are then transmitted to the Rating Recalculation and Statistical Processor (120). Within this module, the Rating Extractor (121) isolates numeric ratings associated with each relevant review. For textual reviews lacking explicit scores, the Sentiment Analyzer (122) interprets linguistic tone to infer approximate rating values. The Weighting Module (123) assigns relative importance to each rating based on parameters such as recency, reviewer credibility, or review length. The Average and Confidence Calculator (124) computes a weighted mean rating and determines a confidence value, such as a confidence interval or standard error of the mean, reflecting statistical reliability. In embodiments employing artificial-intelligence enhancements, a Machine-Learning Model (125) may iteratively refine these computations by learning correlations between textual sentiment, contextual keywords, and user feedback data.

The resulting output is delivered to the Contextual Rating Display (130), which forms part of the user interface and presents the recalculated, context-specific rating alongside optional supporting statistics such as review count and confidence level. The arrangement of these components allows users to dynamically generate and visualize context-dependent ratings that more accurately represent the quality of a product or service within a specific usage scenario.

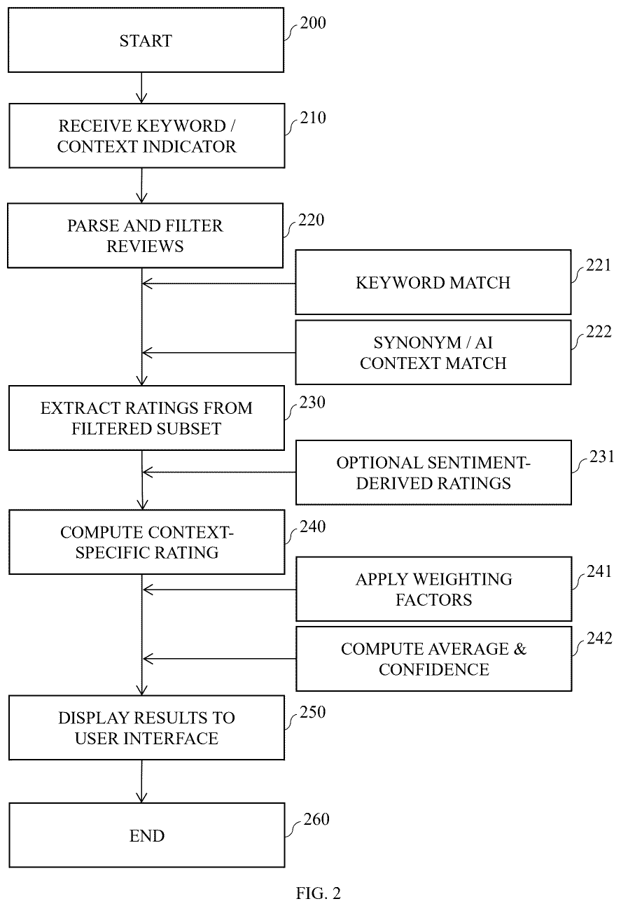

With reference to FIG. 2, a representative flow of the context-specific dynamic rating recalculation method is shown. The process begins at Start (200) and advances to Receive Keyword or Context Indicator (210), in which the user inputs a keyword such as “Dinner,” “Delivery,” or any phrase defining a desired context. The system then proceeds to Parse and Filter Reviews (220), examining all stored review records to identify those relevant to the provided context. Within this operation, the Keyword Match (221) module performs direct lexical matching, while the Synonym or AI Context Match (222) module optionally employs semantic and natural-language-processing models to capture conceptually similar expressions.

Once the relevant subset of reviews is identified, the algorithm executes Extract Ratings from Filtered Subset (230). Where reviews contain no explicit numeric rating, the optional Sentiment-Derived Ratings (231) function applies a sentiment-analysis model to infer approximate scores. The gathered ratings are forwarded to Compute Context-Specific Rating (240), where Apply Weighting Factors (241) adjusts the influence of each review according to attributes such as recency, reviewer reliability, or length, and Compute Average and Confidence (242) produces both a weighted mean and an associated statistical confidence level, such as a standard error or confidence interval.

Following computation, the system performs Display Results to User Interface (250), presenting the recalculated context-specific rating alongside supporting information such as sample size and confidence percentage. The process terminates at End (260) after successful presentation. This procedural sequence enables users to obtain accurate, context-dependent performance insights while maintaining computational transparency and repeatability.

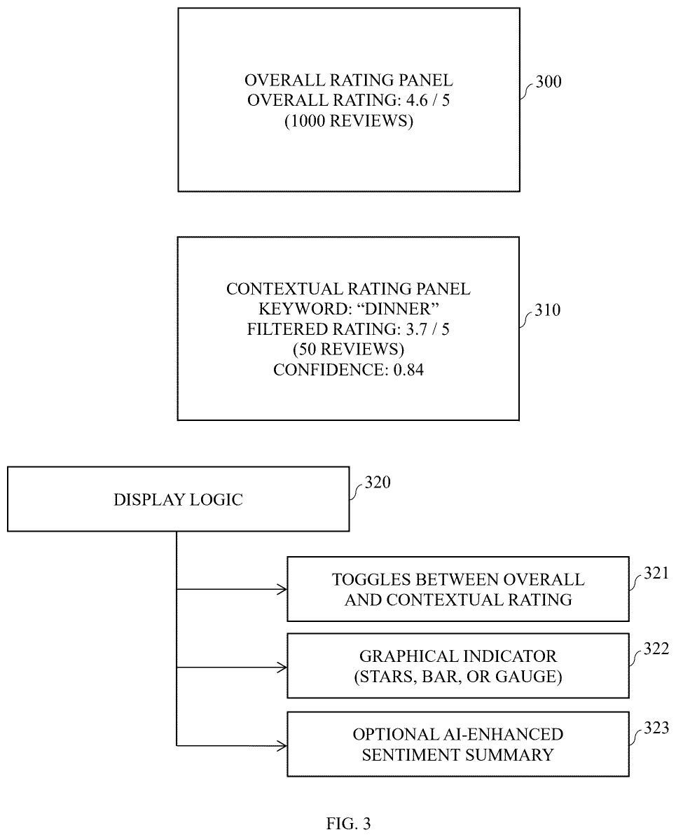

Turning now to FIG. 3, an exemplary user-interface embodiment is shown for visually communicating overall versus context-specific performance metrics. The interface comprises an Overall Rating Panel (300), which displays the aggregate score generated from all available reviews—illustrated here as 4.6 based on 1000 reviews—and a Contextual Rating Panel (310) that presents a recalculated score corresponding to a user-selected context or keyword. In the example shown, when the keyword “Dinner” is applied, the filtered rating produced is 3.7 based on 50 reviews, accompanied by a calculated Confidence Value of 0.84 indicating statistical reliability of the subset average. As shown, the filtered rating (3.7) differs significantly from the overall rating (4.6). Prior art search systems may display deep-linked results or filtered lists (e.g., identifying a specific restaurant from a query), but they do not calculate or display this statistical reliability metric. By presenting the Confidence Value 0.84, the interface informs the user that the “3.7” rating has a calculated degree of uncertainty, preventing the user from being misled by the small sample size (50 reviews).

The two panels operate under the control of a Display Logic Module (320). Within this module, a Toggle Control (321) enables the user to switch seamlessly between the overall and contextual panels. A Graphical Indicator (322), such as a row of stars, a horizontal bar, or a gauge element, provides an intuitive visual representation of rating magnitude. An Optional AI-Enhanced Sentiment Summary (323) component may supplement numeric values with a concise text summary or color cue derived from sentiment analysis of the filtered subset.

By enabling immediate visual comparison between overall and context-specific ratings, this embodiment improves user comprehension and transparency. Users can readily determine how a product or service performs under specific conditions (for example, “Dinner” versus “Brunch”) without reviewing individual feedback entries, thereby enhancing the decision-making value of the presented information.

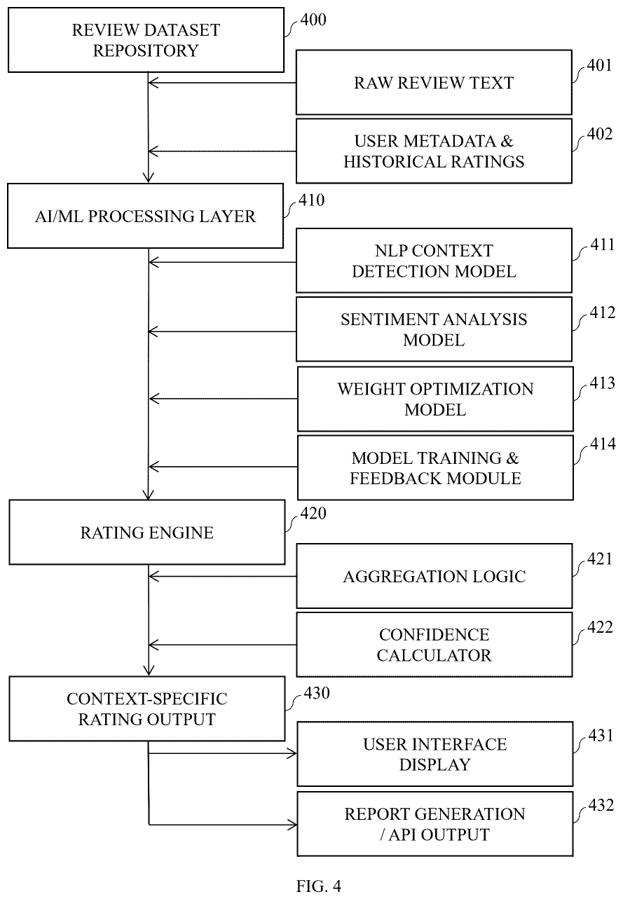

As illustrated in FIG. 4, an enhanced embodiment of the context-specific dynamic rating algorithm employs artificial-intelligence and machine-learning techniques to improve contextual detection, sentiment inference, and confidence estimation. A Review Dataset Repository (400) stores incoming Raw Review Text (401) together with User Metadata and Historical Ratings (402) that provide background information for training and weighting models. The data flow proceeds to the AI/ML Processing Layer (410), which performs advanced textual and statistical analysis. Within this layer, the NLP Context Detection Model (411) identifies semantic relationships between the user-specified context indicator and the review corpus, even where explicit keywords are absent. The Sentiment Analysis Model (412) evaluates unscored text to infer positive or negative sentiment values. The Weight Optimization Model (413) dynamically adjusts weighting factors based on variables such as reviewer credibility, temporal decay, or textual certainty. The Model Training and Feedback Module (414) continuously refines model parameters using accuracy metrics or user feedback data.

Processed results are delivered to the Rating Engine (420), which performs the final computation of the contextual rating. Within the rating engine, the Aggregation Logic (421) combines weighted rating values, and the Confidence Calculator (422) determines statistical reliability or confidence intervals associated with the computed rating. The completed Context-Specific Rating Output (430) is presented visually through the User Interface Display (431) and may be distributed programmatically through Report Generation/API Output (432). This embodiment demonstrates how artificial-intelligence and machine-learning components can enhance the precision, adaptability, and real-time recalibration capability of the core algorithm while remaining consistent with the invention's foundational principles of context-filtered rating computation.

### G. Optional AI/ML Enhancements

In some embodiments, filtering and rating recalculation may be augmented with artificial intelligence (AI) or machine learning (ML) techniques. For example:
i. An NLP model may identify contextually relevant reviews that do not explicitly contain the keyword.
ii. A sentiment-analysis model may generate inferred ratings for reviews without numeric ratings.
iii. ML models may adjust weighting factors dynamically to improve rating accuracy.

These AI/ML enhancements are optional and do not limit the core invention, which can operate fully with standard keyword matching and arithmetic aggregation.

### H. Illustrative Example

Suppose a restaurant holds 1000 reviews with an overall rating of 4.6. When a user filters reviews by the keyword “dinner,” the algorithm identifies 50 relevant reviews and recalculates a contextual average of 3.7. This indicates that the dinner service experience differs from the general consensus. The system may optionally highlight such deviations or display confidence intervals to improve decision-making.

### INDUSTRIAL APPLICABILITY

The invention described herein possesses industrial applicability in a wide range of fields concerned with the collection, analysis, and presentation of user-generated feedback and ratings. Specifically, the context-specific dynamic rating algorithm has utility in data processing, sentiment analysis, analytics, e-commerce platforms, software and mobile applications, social media, and the travel and hospitality industries. The system can be deployed to provide consumers with highly accurate, context-specific performance insights for products, services, or venues (e.g., filtering a restaurant's rating to a “Dinner” or “Delivery” score). Furthermore, the disclosed method is capable of implementation in any digital environment that relies on aggregating diverse textual and numeric review data to generate meaningful, filtered metrics, thereby improving consumer decision-making and data transparency.

1. A computer-implemented method for dynamically recalculating a review rating based on contextual filters applied to user-generated content, the method comprising:
receiving a plurality of reviews, each review including review text and a numeric rating;
receiving a user-specified context indicator comprising a keyword or phrase;
filtering the plurality of reviews to identify a subset of reviews contextually related to the user-specified context indicator;
extracting numeric ratings from the filtered subset, or inferred ratings derived from sentiment analysis where a numeric rating is absent; and
computing a context-specific rating and a corresponding statistical confidence metric using the extracted ratings, wherein the confidence metric is based on the size or variance of the filtered subset, and outputting the context-specific rating and the corresponding confidence metric to a user interface.

2. The method of claim 1, wherein filtering the plurality of reviews comprises performing keyword or phrase matching on review text.

3. The method of claim 1, further comprising applying sentiment analysis to reviews without explicit numeric ratings to generate inferred ratings.

4. The method of claim 1, further comprising weighting reviews based on one or more factors selected from the group consisting of recency, reviewer credibility, review length, and review helpfulness.

5. The method of claim 1, wherein computing the corresponding confidence metric includes calculating the standard error of the mean (SEM) or a confidence interval (CI) of the extracted ratings, wherein the SEM is calculated as a ratio of the standard deviation (o) to the square root of the filtered subset size (n).

6. The method of claim 1, further comprising dynamically adjusting a visual parameter of the context-specific rating, wherein the visual parameter is selected from the group consisting of color saturation, opacity, or size based on the calculated confidence metric, or suppressing the display of the context-specific rating entirely if the confidence metric falls below a predetermined threshold.

7. The method of claim 1, wherein filtering and rating computation are augmented by a machine learning model trained to identify contextually relevant reviews or optimize weighting factors.

8. The method of claim 7, wherein the machine learning model utilizes Natural Language Processing (NLP) techniques to perform at least one of: semantic matching for contextual filtering, or sentiment inference for rating extraction.

9. The method of claim 7, further comprising retraining the machine learning model based on user feedback or accuracy evaluation of generated context-specific ratings.

10. The method of claim 7, wherein the machine learning model comprises a neural or transformer-based network trained on historical review datasets to improve keyword association and contextual understanding.

11. A system for dynamically recalculating a review rating based on contextual filters applied to user-generated content, comprising:
a memory storing instructions; and
a processor configured to execute the instructions to perform the steps of:
receiving a plurality of reviews, each review including review text and a numeric rating;
receiving a user-specified context indicator comprising a keyword or phrase;
filtering the plurality of reviews to identify a subset of reviews contextually related to the user-specified context indicator;
extracting numeric ratings from the filtered subset, or inferred ratings derived from sentiment analysis where a numeric rating is absent; and
computing a context-specific rating and a corresponding statistical confidence metric using the extracted ratings, wherein the confidence metric is based on the standard error of the mean (SEM) or a confidence interval (CI) of the extracted ratings, and wherein the SEM is calculated as a ratio of the standard deviation (o) to the square root of the filtered subset size (n), and outputting the context-specific rating and confidence metric to a user interface.

12. The system of claim 11, wherein the processor is further configured to perform sentiment analysis on reviews without explicit numeric ratings.

13. The system of claim 11, wherein the processor applies weighting to ratings based on recency, reviewer credibility, or review helpfulness.

14. The system of claim 11, further comprising a machine learning model configured to: i) identify contextually relevant reviews via semantic matching; and ii) generate inferred sentiment scores for unrated reviews.

15. The system of claim 11, wherein the processor is further configured to continuously retrain the machine learning model based on user interactions and updated review data.

16. A non-transitory computer-readable medium storing instructions which, when executed by a processor, cause the processor to perform the method of any one of claim 1.

17. The computer-readable medium of claim 16, wherein the instructions further cause the processor to perform sentiment analysis for unrated reviews.

18. The computer-readable medium of claim 16, wherein the instructions further cause the processor to apply a machine learning model to adjust the context-specific rating.

19. The computer-readable medium of claim 16, wherein the instructions define a machine learning model configured for contextual keyword expansion and semantic matching.

20. The computer-readable medium of claim 16, wherein the operations further include instructions for dynamically updating parameters of the machine learning model based on performance accuracy or user-provided relevance feedback.
